(19) United States
(12) Patent Application Publication
(10) Pub. No.: US 2026/0239088 A1
(43) Pub. Date: Aug. 13, 2026

(54) METHODS FOR SIGNALLING TRAFFIC ASSISTANCE AND DEVICE INFORMATION

(71) Applicant: Telefonaktiebolaget LM Ericsson (publ), Stockholm (SE)

(72) Inventors: Fabian DE LAVAL, Täby (SE); Bikramjit SINGH, Raseborg (FI); Jonas FRÖBERG OLSSON, Ljungsbro (SE); Lars FALK, Malmö (SE); Nianshan SHI, Järfälla (SE); Du Ho KANG, Sollentuna (SE); Richard TANO, Stockholm (SE)

(21) Appl. No.: 19/156,743

(22) PCT Filed: Feb. 16, 2024
(86) PCT No.: PCT/EP2024/053957

§ 371 Date: Aug. 14, 2025

Related U.S. Application Data
(60) Provisional application No. 63/485,643, filed on Feb. 17, 2023.

(51) Int. Cl. H04W 28/02; H04L 47/283; H04W 24/10

(52) U.S. Cl. CPC H04W 28/02; H04L 47/283; H04W 24/10

(57) ABSTRACT

A method, network node and wireless device (WD) for signaling traffic assistance and device information are disclosed. According to one aspect, a method in a network node includes receiving traffic assistance and device information (TADI) the TADI including updated traffic pattern information, the updated traffic pattern information including jitter information associated with traffic flows. The method includes scheduling transmissions based at least in part on the TADI.

### TECHNICAL FIELD

The present disclosure relates to wireless communications, and in particular, to signaling traffic assistance and device information.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### Radio Resource Control

The Radio Resource Control (RRC) protocol specification is detailed in 3GPP Technical Specification (TS) 38.331. This specification provides RRC procedures, functions, messages, encodings of message, error handling, etc. On a high level, the RRC protocol is a WD state machine that is configured and controlled by the network node, to control the activation of features and configurations of lower layer protocols in the WD.

A WD is either in RRC_CONNECTED state or in RRC_INACTIVE state when an RRC connection has been established. If this is not the case, i.e., no RRC connection is established, the WD is in RRC_IDLE state. The RRC states may further be characterized as follows:
RRC_IDLE:
   A WD specific discontinuous reception (DRX) may be configured by upper layers;
      WD controlled mobility based on network configuration;
      The WD:
         Monitors Short Messages transmitted with P-radio network temporary identifier (RNTI) over downlink control information (DCI) (see clause 6.5);
         Monitors a Paging channel for core network (CN) paging using 5G-S3-temporary mobile subscriber identifier (TMSI);
         Performs neighbouring cell measurements and cell (re-)selection;
         Acquires system information and may send SI request (if configured).
RRC_INACTIVE:
   A WD specific discontinuous reception (DRX) may be configured by upper layers or by RRC layer;
   WD controlled mobility based on network configuration;
   The WD stores the WD Inactive access stratum (AS) context;
   A radio access network (RAN)-based notification area is configured by RRC layer;
   The WD:
      Monitors Short Messages transmitted with P-RNTI over DCI (see clause 6.5);
      Monitors a Paging channel for CN paging using 5G-S-temporary mobile subscriber identity (TMSI) and RAN paging using full-RNTI;
      Performs neighbouring cell measurements and cell (re-)selection;
      Performs RAN-based notification area updates periodically and when moving outside the configured RAN-based notification area;
      Acquires system information and may send SI request (if configured);
RRC_CONNECTED:
   The WD stores the AS context;
   Transfer of unicast data to/from WD;
   At lower layers, the WD may be configured with a WD specific DRX;
   For WDs supporting carrier aggregation (CA), use of one or more secondary cells (SCells), aggregated with the special primary cell (SpCell), for increased bandwidth;
   For WDs supporting dual connectivity (DC), use of one secondary carrier group (SCG), aggregated with the master carrier group (MCG), for increased bandwidth;
   Network controlled mobility within NR and to/from evolved universal terrestrial access (E-UTRA);
   The WD:
      Monitors Short Messages transmitted with P-RNTI over DCI (see clause 6.5), if configured;
      Monitors control channels associated with the shared data channel to determine if data is scheduled for it;
      Provides channel quality and feedback information;
      Performs neighbouring cell measurements and measurement reporting;
      Acquires system information.

### WD Assistance Information

The WD (WD) Assistance Information (UAI) is an RRC message that may be sent any time after the RRC reconfiguration procedure.

The purpose of the UAI procedure is to inform the network of the WD's delay budget report carrying desired increment/decrement in the connected mode DRX cycle length, or overheating assistance information.

A WD capable of providing delay budget report in RRC_CONNECTED may initiate the procedure in several cases, including upon being configured to provide delay budget report and upon change of delay budget preference.

A WD capable of providing overheating assistance information in RRC_CONNECTED may initiate the procedure if it was configured to do so, upon detecting internal overheating, or upon detecting that it is no longer experiencing an overheating condition.

Note: upon reception of UAI, it is optional for network node to use the provided assistance information.

The WDAssistanceInformation message is used for the indication of WD assistance information to the network.

```
      Signalling radio bearer: SRB1
      RLC-SAP: AM
      Logical channel: DCCH
      Direction: WD to Network
```

UEAssistanceInformation message

```
  -- ASN1START
  -- TAG-UEASSISTANCEINFORMATION-START
```

| | |
|---|---|
| UEAssistanceInformation ::= | SEQUENCE { |
| criticalExtensions | CHOICE { |
| ueAssistanceInformation | WDAssistanceInformation-IEs, |
| criticalExtensionsFuture | SEQUENCE { } |

```
    }
  }
```

| UEAssistanceInformation-IEs ::= | SEQUENCE { | |
|---|---|---|
| delayBudgetReport | DelayBudgetReport | OPTIONAL, |
| lateNonCriticalExtension | OCTET STRING | OPTIONAL, |

| | |
|---|---|
| nonCriticalExtension | WDAssistanceInformation-v1540-IEs |

OPTIONAL
}

| | |
|---|---|
| DelayBudgetReport::= | CHOICE { |
| type1 | ENUMERATED { |
| | msMinus1280, msMinus640, msMinus320, |

msMinus160,msMinus80, msMinus60, msMinus40,

msMinus20, ms0, ms20,ms40, ms60, ms80, ms160,

```
ms320, ms640, ms1280},
    ...
  }
  UEAssistanceInformation-v1540-IEs ::= SEQUENCE {
```

| | | |
|---|---|---|
| overheatingAssistance | OverheatingAssistance | OPTIONAL, |
| nonCriticalExtension | SEQUENCE { } | OPTIONAL |

}

| | |
|---|---|
| OverheatingAssistance ::= | SEQUENCE { |
| reducedMaxCCs | SEQUENCE { |
| reducedCCsDL | INTEGER (0..31), |
| reducedCCsUL | INTEGER (0..31) |

} OPTIONAL,

| | |
|---|---|
| reducedMaxBW-FR1 | SEQUENCE { |
| reducedBW-FR1-DL | ReducedAggregatedBandwidth, |
| reducedBW-FR1-UL | ReducedAggregatedBandwidth |

} OPTIONAL,

| | |
|---|---|
| reducedMaxBW-FR2 | SEQUENCE { |
| reducedBW-FR2-DL | ReducedAggregatedBandwidth, |
| reducedBW-FR2-UL | ReducedAggregatedBandwidth |

} OPTIONAL,

| | |
|---|---|
| reducedMaxMIMO-LayersFR1 | SEQUENCE { |
| reducedMIMO-LayersFR1-DL | MIMO-LayersDL, |
| reducedMIMO-LayersFR1-UL | MIMO-LayersUL |

} OPTIONAL,

| | |
|---|---|
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

```
    } OPTIONAL
  }
  ReducedAggregatedBandwidth ::= ENUMERATED {mhz0, mhz10, mhz20,
mhz30, mhz40, mhz50, mhz60, mhz80, mhz100, mhz200, mhz300, mhz400}
  -- TAG-UEASSISTANCEINFORMATION-STOP
  -- ASN1STOP
```

### Application Layer Measurement Reporting

The purpose of this procedure is to send application layer measurement reports to the network.

A WD capable of application layer measurement reporting in RRC_CONNECTED may initiate the procedure when configured with application layer measurement, i.e., when appLayerMeasConfig and SRB4 have been configured by the network.

Upon initiating the procedure, the WD shall:
1> for each measConfigAppLayerId received from upper layers:
   2> if the WD AS has received application layer measurement report from upper layers which has not been transmitted; and
   2> if the application layer measurement reporting has not been suspended for the measConfigAppLayerId associated with the application layer measurement report according to clause 5.3.5.13d:
      3> set the measReportAppLayerContainer in the MeasurementReportAppLayer message to the received value in the application layer measurement report;
   2> set the measConfigAppLayerId in the MeasurementReportAppLayer message to the value of the measConfigAppLayerId received together with application layer measurement report information;
   2> if session start or stop information has been received from upper layers for the measConfigAppLayerId:
      3> set the appLayerSessionStatus in the MeasurementReportAppLayer message to the received value of session start or stop information;
   2> if RAN visible application layer measurement report has been received from upper layers:
      3> for each appLayerBufferLevel value in the received RAN visible application layer measurement report:
         4> set the appLayerBufferLevel values in the appLayerBufferLevelList in the MeasurementReportAppLayer message to the buffer level values received from the upper layer in the order with the first appLayerBufferLevel value set to the newest received buffer level value, the second appLayerBufferLevel value set to the second newest received buffer level value, and so on until all the buffer level values received from the upper layer have been assigned or the maximum number of values have been set according to appLayerBufferLevel, if configured;
      3> set the playoutDelayForMediaStartup in the MeasurementReportAppLayer message to the received value of playout delay for media startup in the RAN visible application layer measurement report, if any;
      3> for each PDU session ID value indicated in the received RAN visible application layer measurement report, if any:
         4> set the PDU-SessionID field in the pdu-SessionIdList in the MeasurementReportAppLayer message to the indicated PDU session ID value;
1> if the encoded RRC message is larger than the maximum supported size of one PDCP SDU specified in TS 38.323 [5]:
   2> if the RRC message segmentation is enabled based on the field rrc-SegAllowed received in appLayerMeasConfig:
      3> initiate the UL message segment transfer procedure as specified in clause 5.7.7;
   2> else:
      3> discard the RRC message;
1> else:
   2> submit the MeasurementReportAppLayer message to lower layers for transmission upon which the procedure ends.

### XR Traffic Characteristics

Extended Reality (XR) applications typically generate traffic flows which are in principle periodic, e.g., video traffic with 30, 60, 90, or 120 frames per second (fps). However, the traffic arrival moment at the RAN is affected by jitter around the periodicity value, due to processing of the frames at the application (e.g., for compression) and the capabilities of the platform used by the application, as well as transmission through the Core Network. This is modelled in 3GPP Technical Specification (TS) 38.838, by assuming that each data frame arriving at the RAN has a random jitter of [−4; +4] ms (optionally [−5; +5] ms) around the main periodicity. The probability of the jitter value within this interval is given by a truncated Gaussian distribution with mean 0 ms and standard deviation 2 ms.

However, it is expected that XR traffic is more dynamic. In response to events such as network events (congestion indications) or application/user triggered events, XR traffic is likely to adapt or change its traffic pattern. For example, an application may react to congestion notification and may react by lowering the transferred video quality, lowering the bitrate. In another example the application may react by lower the frame rate, for example from 90 fps to 30 fps. Such adaptation is likely to impact the characteristics of the traffic pattern e.g., periodicity.

XR traffic has strict delay requirements, in terms of packet delay budget (PDB). This is the maximum tolerable delay for a packet to be transmitted from a network node to a WD. The PDB value depends on the XR traffic type and is overall between 5 ms and 30 ms.

### 3GPP Background SA2 Conclusions, RAN2 Agreements

In 3GPP, the working group (WG) System Architecture 2 (SA2) has concluded in the study item: “Study on XR (Extended Reality) and media services” for 3GPP Technical Release 18 (3GPP Rel-18) in Technical Release (TR) 23.700-60v1.3.0 that:

“The following information, to be provided to the NG-RAN at PDU Session Establishment/Modification via an NGAP Message, is taken as baseline for normative work:
Periodicity for UL and DL traffic of the QoS Flow. In addition to integer periodicity values, non-integer values associated to, e.g., 15 FPS, 30 FPS, 45 FPS, 60 FPS, 72 FPS, 90 FPS, 120 FPS, shall be supported. Such information shall be exchanged by re-using/extending the TSCAI/TSCAC definitions in clause 5.27.2.1 of 3GPP TS 23.501 V18.0.0:
NOTE 1: The above information may be provided to the 5GC by the AF via an NEF API. The 5GC may further derive, or be configured, with such information;
Traffic jitter information (e.g., jitter range) associated with each periodicity. The SMF requests the UPF to derive jitter (i.e., N6 jitter) for a given periodicity. 5GC derives jitter information accordingly and forwards it to the RAN along with periodicity:
NOTE 2: How the UPF derives the jitter is left for implementation. How the SMF obtains and provides the jitter information will be defined in the normative phase.”
In addition, the RAN2 WG has in the study item: “Study on XR enhancements for NR” for 3GPP Rel-18 accepted the SA2 conclusions and stated the following in 3GPP Technical Report (TR) 38.835 V1.0.0:
“
   Delivery of some assistance information (e.g., periodicity) reusing TSCAI as a baseline. Whether additional mechanism is required may be further considered with an assumption that all information may not be always available at WD application.”

Furthermore, RAN2 has in a new work item (New WID for XR Enhancements RP-223502) on capacity enhancements for XR agreed to:
“Specify the enhancements related to capacity:
   Multiple CG PUSCH transmission occasions in a period of a single CG PUSCH configuration (RAN1, RAN2);
   Dynamic indication of unused CG PUSCH occasion(s) based on UCI by the WD (RAN1);
   BSR enhancements including at least new BS Table(s); (RAN2);
   Delay reporting of buffered data in uplink; (RAN2);
   Provision of XR traffic assistance information for DL and UL (e.g., periodicity); (RAN2);
   Discard operation of PDU Sets (RAN2);”

The term packet data unit (PDU) Set has been defined by 3GPP working group SA2 in 3GPP TR 23.700-60 V18.0.0 (Study on XR (Extended Reality) and media services 3GPP Rel 18) and accepted by RAN2 in 3GPP TR 38.835 V1.0.0 (Study on XR enhancements for NR) and is defined as:

PDU Set: A PDU Set is composed of one or more PDUs carrying the payload of one unit of information generated at the application level (e.g., a frame or video slice for XRM Services, as used in 3GPP TR 26.926). In some implementations, all PDUs in a PDU Set are needed by the application layer to use the corresponding unit of information. In other implementations, the application layer may still recover parts or all of the information unit, when some PDUs are missing.

A problem with existing agreements/technology in SA2/RAN2 is that time sensitive communication assistance information (TSCAI) in only provided in the PDU Session Establishment/Modification procedure through the Next Generation application protocol (NGAP). These procedures require extensive signaling between various core network entities, WD and RAN and thus may be too slow to adapt to changes in XR traffic pattern.

### SUMMARY

Some embodiments advantageously provide methods, network nodes and WDs for signaling traffic assistance and device information.

To enable faster adaptation of RAN features to a dynamic XR traffic pattern, solutions that provide faster updated traffic information are needed. The end result may lead to more efficient scheduling solutions yielding a higher system capacity.

Some embodiments include solutions and methods for the WD to report Traffic Assistance and Device Information (TADI) for low latency interactive applications.

Some embodiments may:
Provide new information in RRC to signal updates of traffic characteristics, referred to as Traffic Assistance and Device Information (TADI);
Provide new information in a medium access control (MAC) control element (CE) to signal updates of traffic characteristics, referred to as Traffic Characteristics Assistance Information;
Provide new information in MeasurementReportAppLayer to signal updates of traffic characteristics, referred to as Traffic Characteristics Assistance Information;
Provide triggers for signaling TADI; and/or
Provide new WD capabilities to signal TADI.

According to one aspect, a wireless device, WD, configured to communicate with a network node, is provided. The WD is configured to determine traffic assistance and device information, TADI, the TADI including updated traffic pattern information, the updated traffic pattern information including jitter information associated with traffic flows. The WD is also configured to transmit the TADI to the network node.

According to this aspect, in some embodiments, the jitter information at least one of a standard deviation, range, maximum and minimum associated with the traffic flows. In some embodiments, the traffic flows are mapped to one of a data radio bearer, a logical channel and a logical channel group. In some embodiments, the WD is configured to signal a capability to provide the TADI. In some embodiments, the WD is configured to transmit the TADI in a radio resource control, RRC, message. In some embodiments, the WD is configured to apply a prohibition timer to prohibit additional transmissions of the TADI for a duration of the prohibition timer. In some embodiments, a start time of the prohibition timer is configured by the network node via a radio resource control, RRC, message. In some embodiments, the prohibition timer is applied to a first set of TADI transmissions having a lower priority that a second set of TADI transmissions. In some embodiments, the WD is configured to apply a minimum time between TADI transmissions. In some embodiments, the TADI is transmitted in response to a request from the network node. In some embodiments, the WD is configured to deactivate TADI transmissions when deactivation is indicated by the network node. In some embodiments, the WD is configured to transmit the TADI in a medium access control, MAC, control element, CE. In some embodiments, the MAC CE is transmitted in a physical uplink shared channel, PUSCH, when the WD has an uplink grant. In some embodiments, the MAC CE is associated with one of a logical channel and a logical channel group, and the WD is configured to include the MAC CE in a physical uplink shared channel, PUSCH, when logical channel prioritization rules for the one of the logical channel and the logical channel group are fulfilled. In some embodiments, a first part of the TADI is transmitted in a radio resource control, RRC, message and a second part of the TADI is transmitted in a medium access control, MAC, control element, CE, message.

According to another aspect, a method in a wireless device, WD, configured to communicate with a network node, is provided. The method includes determining traffic assistance and device information, TADI, the TADI including updated traffic pattern information, the updated traffic pattern information including jitter information associated with traffic flows. The method also includes transmitting the TADI to the network node.

According to this aspect, in some embodiments, the jitter information at least one of a standard deviation, range, maximum and minimum associated with the traffic flows. In some embodiments, the traffic flows are mapped to one of a data radio bearer, a logical channel and a logical channel group. In some embodiments, the method includes signaling a capability to provide the TADI. In some embodiments, the method includes transmitting the TADI in a radio resource control, RRC, message. In some embodiments, the method includes applying a prohibition timer to prohibit additional transmissions of the TADI for a duration of the prohibition timer. In some embodiments, a start time of the prohibition timer is configured by the network node via a radio resource control, RRC, message. In some embodiments, the prohibition timer is applied to a first set of TADI transmissions having a lower priority that a second set of TADI transmissions. In some embodiments, the method includes applying a minimum time between TADI transmissions. In some embodiments, the TADI is transmitted in response to a request from the network node. In some embodiments, the method includes deactivating TADI transmissions when deactivation is indicated by the network node. In some embodiments, the method includes transmitting the TADI in a medium access control, MAC, control element, CE. In some embodiments, the MAC CE is transmitted in a physical uplink shared channel, PUSCH, when the WD has an uplink grant. In some embodiments, the MAC CE is associated with one of a logical channel and a logical channel group, and the method includes configuring the WD to include the MAC CE in a physical uplink shared channel, PUSCH, when logical channel prioritization rules for the one of the logical channel and the logical channel group are fulfilled. In some embodiments, a first part of the TADI is transmitted in a radio resource control, RRC, message and a second part of the TADI is transmitted in a medium access control, MAC, control element, CE, message.

According to yet another aspect, a network node configured to communicate with a wireless device, WD, is provided. The network node is configured to receive traffic assistance and device information, TADI, the TADI including updated traffic pattern information, the updated traffic pattern information including jitter information associated with traffic flows. The network node is also configured to schedule transmissions based at least in part on the TADI.

According to this aspect, in some embodiments, the jitter information at least one of a standard deviation, range, maximum and minimum associated with the traffic flows. In some embodiments, the network node is configured to receive an indication of a capability of the WD to provide the TADI. In some embodiments, the network node is configured to configure the WD with a prohibition timer to prohibit additional transmissions of the TADI for a duration of the prohibition timer. In some embodiments, the network node is configured to configure the WD to provide a minimum time between TADI transmissions. In some embodiments, the network node is configured to trigger at least one transmission of the TADI by the WD. In some embodiments, the network node is configured to trigger a first set of TADI and a second set of TADI, the first set of TADI having a first set of frame characteristics and the second set of TADI having a second set of frame characteristics. In some embodiments, the first set of frame characteristics include at least one of a set of candidate periodicities, a set of frame size distributions, a current periodicity and a current frame size distribution. In some embodiments, the network node is configured to at least one of activate and deactivate TADI transmissions by the WD. In some embodiments, the network node is configured to trigger transmission of the TADI by the WD based at least in part on a logical channel configuration.

According to another aspect, a method in a network node configured to communicate with a wireless device, WD, is provided. The method includes receiving traffic assistance and device information, TADI, the TADI including updated traffic pattern information, the updated traffic pattern information including jitter information associated with traffic flows. The method includes scheduling transmissions based at least in part on the TADI.

According to this aspect, in some embodiments, the jitter information at least one of a standard deviation, range, maximum and minimum associated with the traffic flows. In some embodiments, the method includes receiving an indication of a capability of the WD to provide the TADI. In some embodiments, the method includes configuring the WD with a prohibition timer to prohibit additional transmissions of the TADI for a duration of the prohibition timer. In some embodiments, the method includes configuring the WD to provide a minimum time between TADI transmissions. In some embodiments, the method includes triggering at least one transmission of the TADI by the WD. In some embodiments, the method includes triggering a first set of TADI and a second set of TADI, the first set of TADI having a first set of frame characteristics and the second set of TADI having a second set of frame characteristics. In some embodiments, the first set of frame characteristics include at least one of a set of candidate periodicities, a set of frame size distributions, a current periodicity and a current frame size distribution. In some embodiments, the method includes at least one of activating and deactivating TADI transmissions by the WD. In some embodiments, the method includes triggering transmission of the TADI by the WD based at least in part on a logical channel configuration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is state diagram for a WD;

FIG. 2 is a timing diagram for RRC configuration;

FIG. 3 is a timing diagram for RRC reconfiguration;

FIG. 4 is a timing diagram for measurement reporting;

FIG. 5 is a schematic diagram of an exemplary network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating exemplary methods implemented in a communication system including a host computer, a network node and a wireless device for executing a client application at a wireless device according to some embodiments of the present disclosure;

FIG. 8 is a flowchart illustrating exemplary methods implemented in a communication system including a host computer, a network node and a wireless device for receiving user data at a wireless device according to some embodiments of the present disclosure;

FIG. 9 is a flowchart illustrating exemplary methods implemented in a communication system including a host computer, a network node and a wireless device for receiving user data from the wireless device at a host computer according to some embodiments of the present disclosure;

FIG. 10 is a flowchart illustrating exemplary methods implemented in a communication system including a host computer, a network node and a wireless device for receiving user data at a host computer according to some embodiments of the present disclosure;

FIG. 11 is a flowchart of an exemplary process in a network node for signaling traffic assistance and device information; and

FIG. 12 is a flowchart of an exemplary process in a wireless device for signaling traffic assistance and device information.

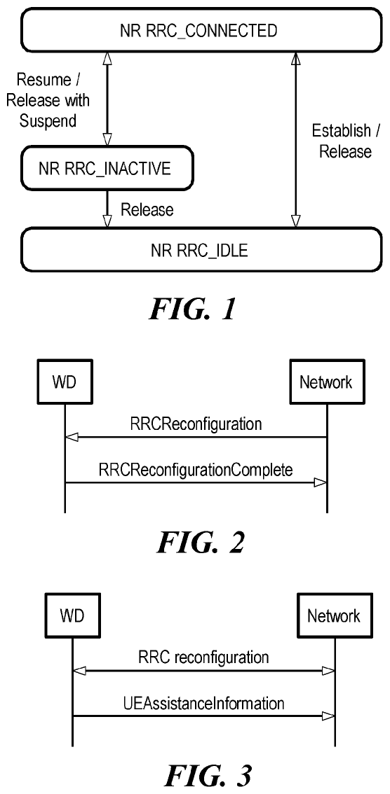

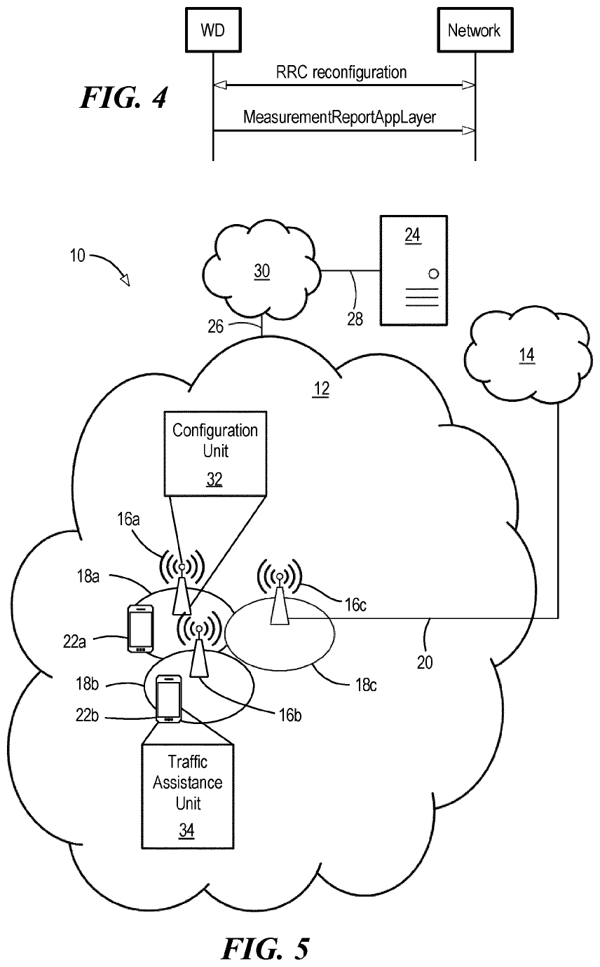

### DETAILED DESCRIPTION

Before describing in detail exemplary embodiments, it is noted that the embodiments reside primarily in combinations of apparatus components and processing steps related to signaling traffic assistance and device information. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide signaling traffic assistance and device information.

Returning now to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which may be configured to configure the WD 22 with a timer configuration to configure a periodicity of traffic assistance information messages. The configuration unit 32 may be configured to receive the TADI, the TADI including updated traffic pattern information, the updated traffic pattern information including jitter information associated with traffic flows, and schedule transmissions based at least in part on the TADI. A wireless device 22 is configured to include a traffic assistance unit 34 which may be configured to configure the periodicity of traffic assistance information messages according to the timer configuration. The traffic assistance unit 34 may be configured to determine traffic assistance and device information, TADI, the TADI including updated traffic pattern information, the updated traffic pattern information including jitter information associated with traffic flows.

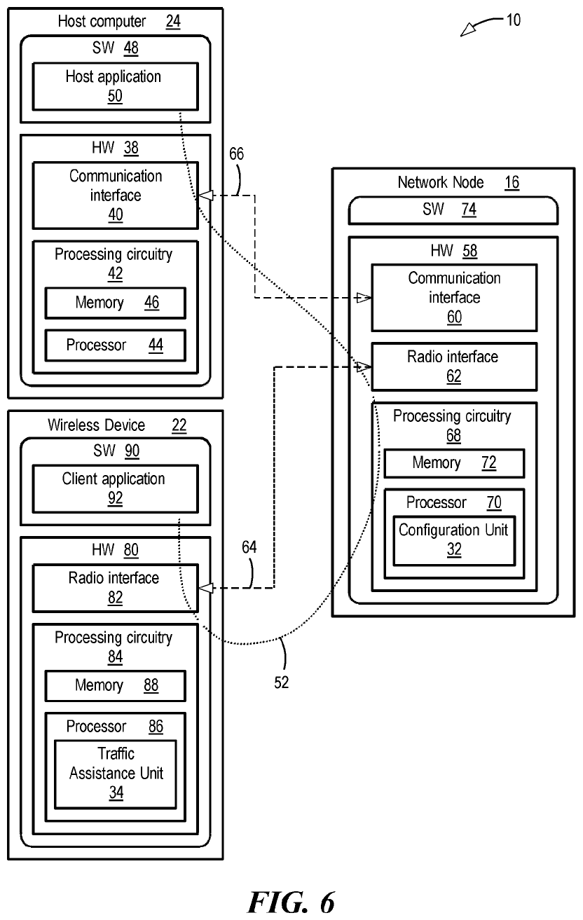

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure the WD 22 with a timer configuration to configure a periodicity of traffic assistance information messages. The configuration unit 32 may be configured to receive TADI, the TADI including updated traffic pattern information, the updated traffic pattern information including jitter information associated with traffic flows, and schedule transmissions based at least in part on the TADI.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a traffic assistance unit 34 configured to a traffic assistance unit 34 which is configured to configure the periodicity of traffic assistance information messages according to the timer configuration. The traffic assistance unit 34 may be configured to determine traffic assistance and device information, TADI, the TADI including updated traffic pattern information, the updated traffic pattern information including jitter information associated with traffic flows.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as configuration unit 32, and traffic assistance unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

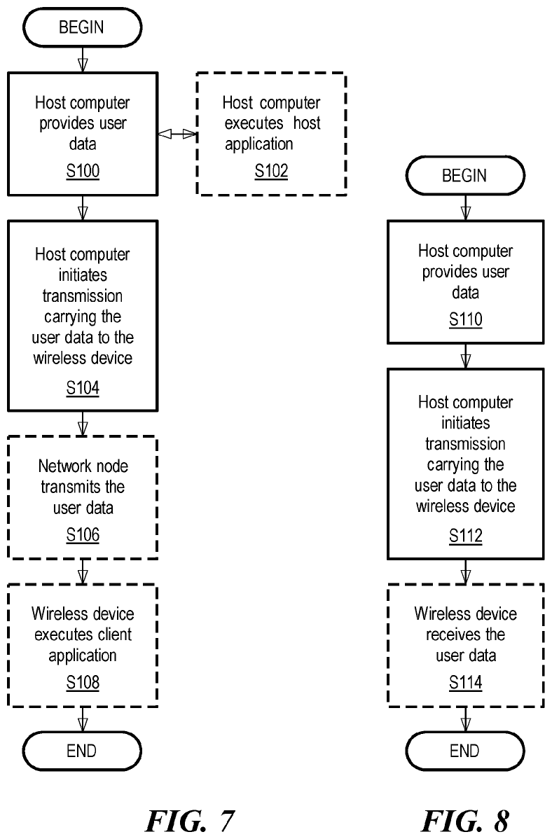

FIG. 7 is a flowchart illustrating an exemplary method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

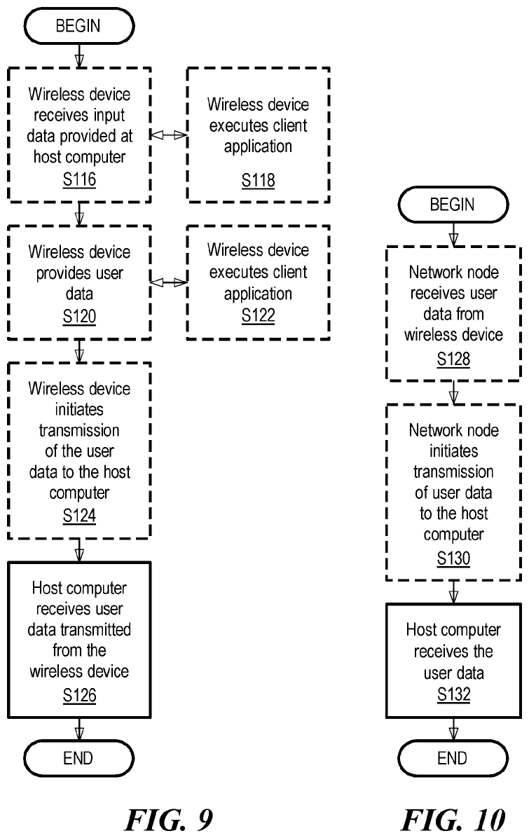

FIG. 9 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 11 is a flowchart of an exemplary process in a network node 16 for signaling traffic assistance and device information. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to receive an indication of a traffic assistance information capability of the WD (Block S134). The process also includes configuring the WD with a timer configuration to configure a periodicity of traffic assistance information messages (Block S136).

In some embodiments, the timer configuration configures the periodicity based at least in part on a priority of a traffic assistance information message. In some embodiments, the timer configuration includes a trigger to trigger reporting of traffic assistance information messages. In some embodiments, the method also includes configuring a format of traffic assistance information. In some embodiments, the method also includes receiving traffic assistance information messages on at least one of radio resource control, RRC, signaling and medium access control, MAC, control element, CE, signaling.

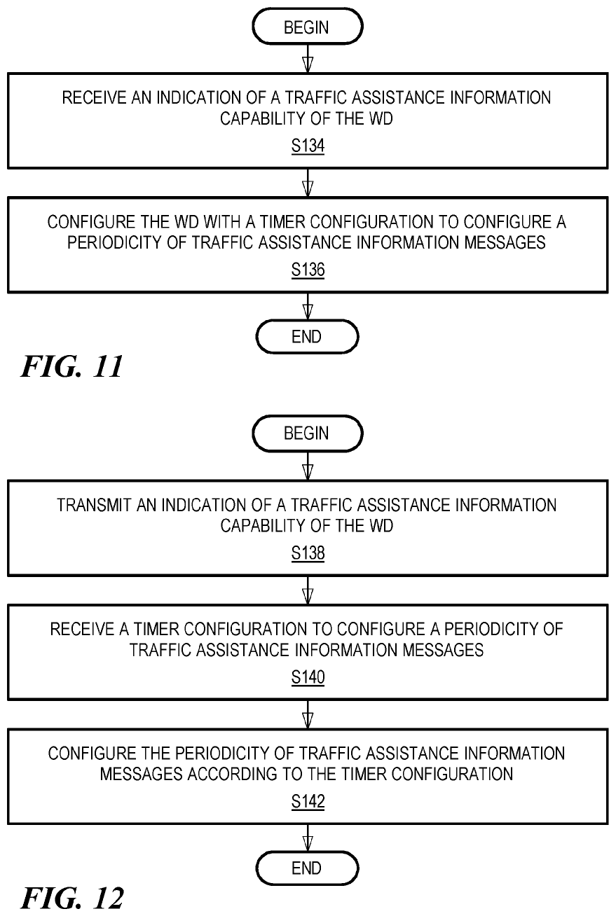

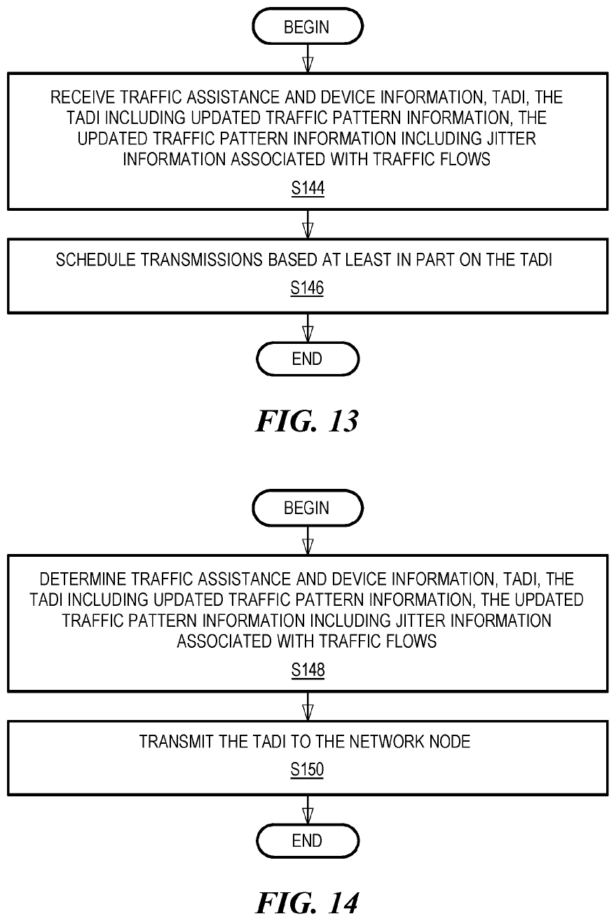

FIG. 12 is a flowchart of an exemplary process in a wireless device 22 according to some embodiments of the present disclosure. One or more blocks described herein may be performed by one or more elements of wireless device 22 such as by one or more of processing circuitry 84 (including the traffic assistance unit 34), processor 86, radio interface 82 and/or communication interface 60. Wireless device 22 such as via processing circuitry 84 and/or processor 86 and/or radio interface 82 is configured to transmit an indication of a traffic assistance information capability of the WD (Block S138). The process also includes receiving a timer configuration to configure a periodicity of traffic assistance information messages (Block S140). The process also includes configuring the periodicity of traffic assistance information messages according to the timer configuration (Block S142).

In some embodiments, the timer configuration configures the periodicity of traffic assistance information messages based at least in part on a priority of a traffic assistance information message. In some embodiments, the process includes reporting traffic assistance information messages in response to a trigger from the network node. In some embodiments, the timer configuration includes a format for the traffic assistance information messages. In some embodiments, the process also includes transmitting the traffic assistance information messages on at least one of radio resource control, RRC, signaling and medium access control, MAC, control element, CE, signaling.

FIG. 13 is a flowchart of an exemplary process in a network node 16 for signaling traffic assistance and device information. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to receive traffic assistance and device information, TADI, the TADI including updated traffic pattern information, the updated traffic pattern information including jitter information associated with traffic flows (Block S144). The method includes scheduling transmissions based at least in part on the TADI (Block S146).

According to this aspect, in some embodiments, the jitter information at least one of a standard deviation, range, maximum and minimum associated with the traffic flows. In some embodiments, the method includes receiving an indication of a capability of the WD 22 to provide the TADI. In some embodiments, the method includes configuring the WD 22 with a prohibition timer to prohibit additional transmissions of the TADI for a duration of the prohibition timer. In some embodiments, the method includes configuring the WD 22 to provide a minimum time between TADI transmissions. In some embodiments, the method includes triggering at least one transmission of the TADI by the WD 22. In some embodiments, the method includes triggering a first set of TADI and a second set of TADI, the first set of TADI having a first set of frame characteristics and the second set of TADI having a second set of frame characteristics. In some embodiments, the first set of frame characteristics include at least one of a set of candidate periodicities, a set of frame size distributions, a current periodicity and a current frame size distribution. In some embodiments, the method includes at least one of activating and deactivating TADI transmissions by the WD 22. In some embodiments, the method includes triggering transmission of the TADI by the WD 22 based at least in part on a logical channel configuration.

FIG. 14 is a flowchart of an exemplary process in a wireless device 22 according to some embodiments of the present disclosure. One or more blocks described herein may be performed by one or more elements of wireless device 22 such as by one or more of processing circuitry 84 (including the traffic assistance unit 34), processor 86, radio interface 82 and/or communication interface 60. Wireless device 22 such as via processing circuitry 84 and/or processor 86 and/or radio interface 82 is configured to determine traffic assistance and device information, TADI, the TADI including updated traffic pattern information, the updated traffic pattern information including jitter information associated with traffic flows (Block S148). The method also includes transmitting the TADI to the network node 16 (Block S150).

According to this aspect, in some embodiments, the jitter information at least one of a standard deviation, range, maximum and minimum associated with the traffic flows. In some embodiments, the traffic flows are mapped to one of a data radio bearer, a logical channel and a logical channel group. In some embodiments, the method includes signaling a capability to provide the TADI. In some embodiments, the method includes transmitting the TADI in a radio resource control, RRC, message. In some embodiments, the method includes applying a prohibition timer to prohibit additional transmissions of the TADI for a duration of the prohibition timer. In some embodiments, a start time of the prohibition timer is configured by the network node 16 via a radio resource control, RRC, message. In some embodiments, the prohibition timer is applied to a first set of TADI transmissions having a lower priority that a second set of TADI transmissions. In some embodiments, the method includes applying a minimum time between TADI transmissions. In some embodiments, the TADI is transmitted in response to a request from the network node 16. In some embodiments, the method includes deactivating TADI transmissions when deactivation is indicated by the network node 16. In some embodiments, the method includes transmitting the TADI in a medium access control, MAC, control element, CE. In some embodiments, the MAC CE is transmitted in a physical uplink shared channel, PUSCH, when the WD 22 has an uplink grant. In some embodiments, the MAC CE is associated with one of a logical channel and a logical channel group, and the method includes configuring the WD 22 to include the MAC CE in a physical uplink shared channel, PUSCH, when logical channel prioritization rules for the one of the logical channel and the logical channel group are fulfilled. In some embodiments, a first part of the TADI is transmitted in a radio resource control, RRC, message and a second part of the TADI is transmitted in a medium access control, MAC, control element, CE, message.

Having described the general process flow of arrangements of the disclosure and having provided examples of hardware and software arrangements for implementing the processes and functions of the disclosure, the sections below provide details and examples of arrangements for signaling traffic assistance and device information.

Herein, it is assumed that the WD 22 has the capability to either receive traffic information from the application layer through a WD application interface or derive the traffic information itself or both. The embodiments and examples listed below are intended to be generic in the sense they may be applicable for non-XR use cases as well. Although the initial idea and intention is to capture solutions that in particular address the XR use case, they are described below in a more generic have a wider application.

In some embodiments, the UAI is updated with a new information element (IE) that signals updated traffic pattern and WD information. In one example, the IE is called TADIUpdate. The IE may signal new updated traffic information such as:
Periodicit(y/-ies) associated with traffic flow mapped on DRB/LCH/LCG x for uplink (UL) only, downlink (DL) only or both;
Jitter information, e.g., statistical parameters, such standard deviation, range, maximum, minimum etc. associated with traffic flows mapped on a DRB/LCH/LCG x for UL only, DL only or both;
Frame rates associated with video traffic flow mapped on DRB/LCH/LCG x for UL only, DL only or both. Information may be provided as whole integer numbers such as 90 fps, 60 fps, 30 fps etc.;
The change of frame rate or expected change of frame rate in a certain time;
Sampling or reporting frequency of sensored data for other non-video traffic such as 6 degree of freedom (DoF), meta data, and spatial map update;
Indication of application encoding rate change or its plan to change or planned target encoding rate;
Video frame size, statistical averages, standard deviation;
End-to-end video frame delay requirement, updated PDU Set delay budget;
Mean data rate and statistical parameters for UL and/or DL traffic;
Number of data flows for UL and/or DL e.g., if multiple video streams are transmitted, audio flow, pose information flow;
PDU set reliability, error rates and target error rates;
Application configuration parameters such as Group of Picture (GoP) size, a configured video frame type, the interval of key frame generation, the option of error correction feedback;
Application compute offloading configuration such as indication of application functionalities that are processed in a remote server, e.g., SLAM (spatial localization and mapping) and rendering;
Configured transport protocol information for applications, e.g., UDP/RTP/TCP;
The QoS parameters and associated traffic information of tethered applications connected to the WD 22;
Device physical limitation such as the max output power, the total battery amount, the maximum number of antenna;
When QoE application measurement is defined for XR, RAN Visible QoE Measurements may be configured to the WD 22 by the network node 16. The network node 16 may pick up a subset of the QoE metrics to enhance its performance;
Indication of associated flows (UL/DL);
Indication of the requested Round Trip Time (RTT) of the associated flows;
Indication of acceptable jitter; and/or
Indication of playout buffer depth.

All of traffic and quality of service (QoS) information may be reported per flows/DRB/LCH/LCG.

Upon reception of the UAI in the network node 16, the network node 16 may use the information to configure enhanced scheduling mechanism, such as configured grants, DRX, pre-scheduling etc.

```
  UEAssistanceInformation message
  -- ASN1START
  -- TAG-UEASSISTANCEINFORMATION-START
```

| | |
|---|---|
| UEAssistanceInformation ::= | SEQUENCE { |
| criticalExtensions | CHOICE { |
| ueAssistanceInformation | WDAssistanceInformation-IEs, |
| criticalExtensionsFuture | SEQUENCE { } |

```
    }
  }
```

| UEAssistanceInformation-IEs ::= | SEQUENCE { | |
|---|---|---|
| delayBudgetReport | DelayBudgetReport | OPTIONAL, |
| lateNonCriticalExtension | OCTET STRING | OPTIONAL, |

| | |
|---|---|
| nonCriticalExtension | WDAssistanceInformation-v1540-IEs |

OPTIONAL
}

| | |
|---|---|
| DelayBudgetReport::= | CHOICE { |
| type1 | ENUMERATED { |
| | msMinus1280, msMinus640, msMinus320, |

msMinus160,msMinus80, msMinus60, msMinus40,

msMinus20, ms0, ms20,ms40, ms60, ms80, ms160,

```
ms320, ms640, ms1280},
    ...
  }
  UEAssistanceInformation-v1540-IEs ::= SEQUENCE {
```

| | | |
|---|---|---|
| overheatingAssistance | OverheatingAssistance | OPTIONAL, |
| nonCriticalExtension | SEQUENCE { } | OPTIONAL |

}

| | |
|---|---|
| OverheatingAssistance ::= | SEQUENCE { |
| reducedMaxCCs | SEQUENCE { |
| reducedCCsDL | INTEGER (0..31), |
| reducedCCsUL | INTEGER (0..31) |

} OPTIONAL,

| | |
|---|---|
| reducedMaxBW-FR1 | SEQUENCE { |
| reducedBW-FR1-DL | ReducedAggregatedBandwidth, |
| reducedBW-FR1-UL | ReducedAggregatedBandwidth |

} OPTIONAL,

| | |
|---|---|
| reducedMaxBW-FR2 | SEQUENCE { |
| reducedBW-FR2-DL | ReducedAggregatedBandwidth, |
| reducedBW-FR2-UL | ReducedAggregatedBandwidth |

} OPTIONAL,

| | |
|---|---|
| reducedMaxMIMO-LayersFR1 | SEQUENCE { |
| reducedMIMO-LayersFR1-DL | MIMO-LayersDL, |
| reducedMIMO-LayersFR1-UL | MIMO-LayersUL |

} OPTIONAL,

| | |
|---|---|
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

```
    } OPTIONAL
  }
```

| | |
|---|---|
| TADIUpdate ::= ... | OPTIONAL |

```
  ReducedAggregatedBandwidth ::= ENUMERATED {mhz0, mhz10, mhz20,
mhz30, mhz40, mhz50, mhz60, mhz80, mhz100, mhz200, mhz300, mhz400}
  -- TAG-UEASSISTANCEINFORMATION-STOP
  -- ASN1STOP
```

In some embodiments, the WD 22 signals its capability to provide information of the traffic pattern and device information updates in a version of the WD-NR-Container as may be seen in the example below.

| | |
|---|---|
| UE-NR-Capability ::= | SEQUENCE { |
| accessStratumRelease | AccessStratumRelease, |
| pdcp-Parameters | PDCP-Parameters, |
| rlc-Parameters | RLC-Parameters |

OPTIONAL,

| | |
|---|---|
| mac-Parameters | MAC-Parameters |

OPTIONAL,

| | |
|---|---|
| phy-Parameters | Phy-Parameters, |
| rf-Parameters | RF-Parameters, |
| measAndMobParameters | MeasAndMobParameters |

OPTIONAL,

| | |
|---|---|
| fdd-Add-UE-NR-Capabilities | WD-NR-Capability AddXDD-Mode |

OPTIONAL,

| | |
|---|---|
| tdd-Add-UE-NR-Capabilities | WD-NR-Capability AddXDD-Mode |

OPTIONAL,

| | |
|---|---|
| fr1-Add-UE-NR-Capabilities | WD-NR-Capability AddFRX-Mode |

OPTIONAL,

| | |
|---|---|
| fr2-Add-UE-NR-Capabilities | WD-NR-Capability AddFRX-Mode |

OPTIONAL,

| | |
|---|---|
| featureSets | FeatureSets |

OPTIONAL,

| | |
|---|---|
| featureSetCombinations | SEQUENCE (SIZE |

| | |
|---|---|
| (1..maxFeatureSetCombinations)) OF FeatureSetCombination | OPTIONAL, |

| | |
|---|---|
| lateNonCriticalExtension | OCTET STRING (CONTAINING WD-NR- |
| Capability-v15c0) | OPTIONAL, |
| nonCriticalExtension | WD-NR-Capability-v1530 |

OPTIONAL

| | |
|---|---|
| TADIUAICapability | ENUMERATED {supported} |

OPTIONAL
}

In some embodiments, the capability may be based on type of signalling, which may be of following types:
RRC (described in previous embodiment);
MAC CE (i.e., the WD possesses a capability for reporting UAI or equivalent information using MAC CE):
   For this MAC CE needs to be designed to depict the range of desired parameters (described in embodiment 1);
PHY signalling such as UCI, e.g., by which the WD 22 may report (a) absolute value or (b) change/update in value of parameters described in 1^{st} embodiment.

In some embodiments, the WD 22 signals its capability to support Traffic Assistance and Device Information in the RRCSetupRequest message.

```
  -- ASN1START
  -- TAG-RRCSETUPREQUEST-START
```

| | |
|---|---|
| RRCSetupRequest ::= | SEQUENCE { |
| rrcSetupRequest | RRCSetupRequest-IEs |

}

| | |
|---|---|
| RRCSetupRequest-IEs ::= | SEQUENCE { |
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, mo- |

Signalling,

mo-Data, mo-VoiceCall, mo-VideoCall, mo-SMS, mps-

PriorityAccess, mcs-PriorityAccess, TADI-Access,

spare5, spare4, spare3, spare2, spare1}

```
  -- TAG-RRCSETUPREQUEST-STOP
  -- ASN1STOP
```

Assume that the network node 16 is aware of the WD 22 capability of transmitting the UAI on updates from application or elsewhere. To limit the number of UAI that may be transmitted in a period, a prohibition timer may be associated with the transmission of UAI. The timer may prohibit additional transmissions of UAI over the duration of the timer. The timer itself may be configured by the network node 16 through an RRC message.

In some embodiments, the network node 16 may define the periodic UAI message transmission resource. The UAI updates may be sent periodically as RRC message or MAC CE (similar to a periodic buffer status report (BSR)).

In some embodiments, the network node 16 signals to the WD 22 in the message RRCReconfiguration, a timer timing a minimum time between UAI messages containing Traffic Assistance and Device Information (TADI) updates. The timer numbers below are example values.

```
  -- ASN1START
  -- TAG-RRCRECONFIGURATION-START
```

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

```
    }
  }
```

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE(1..maxDRB)) OF |
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610-IEs |

OPTIONAL
}

| | |
|---|---|
| RRCReconfiguration-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR- |

| | |
|---|---|
| r16} | OPTIONAL, -- Need M |

| | |
|---|---|
| onDemandSIB-Request-r16 | SetupRelease { OnDemandSIB-Request- |

| | |
|---|---|
| r16 } | OPTIONAL, -- Need M |

| | |
|---|---|
| dedicatedPosSysInfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR- |

| | |
|---|---|
| r16} | OPTIONAL, -- Need M |

| | |
|---|---|
| sl-ConfigDedicatedEUTRA-Info-r16 | SetupRelease {SL- |
| ConfigDedicatedEUTRA-Info-r16} | OPTIONAL, -- Need M |
| targetCellSMTC-SCG-r16 | SSB-MTC |

OPTIONAL, -- Need S

| | |
|---|---|
| nonCriticalExtension | RRCReconfiguration-v1700-IEs |

OPTIONAL
}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 |

| | |
|---|---|
| } | OPTIONAL, -- Need M |

| | |
|---|---|
| sl-L2RemoteUE-Config-r17 | SetupRelease { SL-L2RemoteUE-Config- |

| | |
|---|---|
| r17 } | OPTIONAL, -- Need M |

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG- |

| | |
|---|---|
| ConfigNR-r17} | OPTIONAL, -- Need M |

| | |
|---|---|
| needForGapNCSG-ConfigEUTRA-r17 | SetupRelease |
| {NeedForGapNCSG-ConfigEUTRA-r17} | OPTIONAL, -- Need M |
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG- |
| RequestUL-TDOA-Config-r17} | OPTIONAL, -- Need M |
| nonCriticalExtension | SEQUENCE { } |

OPTIONAL
}

| | |
|---|---|
| MRDC-SecondaryCellGroupConfig ::= | SEQUENCE { |
| mrdc-ReleaseAndAdd | ENUMERATED {true} |

OPTIONAL, -- Need N

| | |
|---|---|
| mrdc-SecondaryCellGroup | CHOICE { |
| nr-SCG | OCTET STRING (CONTAINING |

RRCReconfiguration),

| | |
|---|---|
| eutra-SCG | OCTET STRING |

```
    }
  }
```

| | |
|---|---|
| BAP-Config-r16 ::= | SEQUENCE { |
| bap-Address-r16 | BIT STRING (SIZE (10)) |

OPTIONAL, -- Need M

| | |
|---|---|
| defaultUL-BAP-RoutingID-r16 | BAP-RoutingID-r16 |

OPTIONAL, -- Need M

| | |
|---|---|
| defaultUL-BH-RLC-Channel-r16 | BH-RLC-ChannelID-r16 |

OPTIONAL, -- Need M

| | |
|---|---|
| flowControlFeedbackType-r16 | ENUMERATED {perBH-RLC-Channel, |

| | |
|---|---|
| perRoutingID, both} | OPTIONAL, -- Need R |

```
    ...
  }
```

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING |

```
OPTIONAL, -- Cond securityNASC
    ...
  }
```

| | |
|---|---|
| OnDemandSIB-Request-r16 ::= | SEQUENCE { |
| onDemandSIB-RequestProhibitTimer-r16 | ENUMERATED {s0, s0dot5, s1, |

s2, s5, s10, s20, s30}
}

| | |
|---|---|
| T316-r16 ::= | ENUMERATED {ms50, ms100, ms200, ms300, ms400, ms500, |

ms600, ms1000, ms1500, ms2000}
IAB-IP-AddressConfigurationList-r16 ::= SEQUENCE {

| | |
|---|---|
| iab-IP-AddressToAddModList-r16 | SEQUENCE (SIZE(1..maxIAB-IP- |
| Address-r16)) OF IAB-IP-AddressConfiguration-r16 | OPTIONAL, -- Need N |
| iab-IP-AddressToReleaseList-r16 | SEQUENCE (SIZE(1..maxIAB-IP- |
| Address-r16)) OF IAB-IP-AddressIndex-r16 | OPTIONAL, -- Need N |

```
    ...
  }
```

| | |
|---|---|
| IAB-IP-AddressConfiguration-r16 ::= | SEQUENCE { |
| iab-IP-AddressIndex-r16 | IAB-IP-AddressIndex-r16, |
| iab-IP-Address-r16 | IAB-IP-Address-r16 |

OPTIONAL, -- Need M

| | |
|---|---|
| iab-IP-Usage-r16 | IAB-IP-Usage-r16 |

OPTIONAL, -- Need M

| | |
|---|---|
| iab-donor-DU-BAP-Address-r16 | BIT STRING (SIZE(10)) |

```
OPTIONAL, -- Need M
  ...
  }
```

| | |
|---|---|
| SL-ConfigDedicatedEUTRA-Info-r16 ::= | SEQUENCE { |
| sl-ConfigDedicatedEUTRA-r16 | OCTET STRING |

OPTIONAL, -- Need M

| | |
|---|---|
| sl-TimeOffsetEUTRA-List-r16 | SEQUENCE (SIZE (8)) OF SL- |

| | |
|---|---|
| TimeOffsetEUTRA-r16 | OPTIONAL -- Need M |

}

| | |
|---|---|
| SL-TimeOffsetEUTRA-r16 ::= | ENUMERATED {ms0, ms0dot25, ms0dot5, |

ms0dot625, ms0dot75, ms1, ms1dot25, ms1dot5, ms1dot75,

ms2, ms2dot5, ms3, ms4, ms5, ms6, ms8, ms10,

ms20}
UE-TxTEG-RequestUL-TDOA-Config-r17 ::= CHOICE {

| | |
|---|---|
| oneShot-r17 | NULL, |
| periodicReporting-r17 | ENUMERATED { ms160, ms320, ms1280, |

ms2560, ms61440, ms81920, ms368640, ms737280 }
}

| | |
|---|---|
| TADI-Parameters-r18 ::= | SEQUENCE { |
| TADIUpdateMinInterval-r18 | ENUMERATED {ms50, ms100, ms200, ms300, |
| ms400, ms500, ms600, ms1000, ms1500, ms2000} | OPTIONAL -- Need R |

```
  }
  -- TAG-RRCRECONFIGURATION-STOP
  -- ASN1STOP
```

In some embodiments, the network node 16 may define priority for the changes, allocation of resources for transmitting updates and a triggering mechanism subject to priority. For instance, if the relative periodicity change is less than X %, it may be designated as a low priority UAI update message and if the relative periodicity change is more than X %, it may be designated as a high priority UAI update message. Hence, based on the priority, the resource allocation, triggering mechanisms, other parameters, e.g., timer configuration would apply accordingly. For instance, the UAI update message is of high priority, no timer is applied, and if the UAI update message is of low priority, the timer may be enabled. This would deter frequent transmissions of low priority UAI update messages, but not high priority UAI update messages.

In some embodiments, the network node 16 may send DL messages (RRC, medium access control (MAC), PHY based DL signalling) which include a triggering request for reporting UAI change from the WD 22 (RRC, MAC, PHY based UL signalling).

In some embodiments, the WD 22 is configured by an RRC message to trigger MAC control element (CE) signalling with traffic assistance information. In some embodiments, the RRC IE LogicalChannelConfig is extended with an on/off trigger. A WD 22 MAC layer may receive a signal from a higher layer that traffic assistance information associated with the logical has changed or is updated. The WD 22 may trigger a MAC CE including newly updated traffic assistance information. In some embodiments, the WD 22 transmits the UAI MAC CE message in a PUSCH if the WD 22 has a UL grant; otherwise the MAC procedures trigger a Scheduling Request. In some embodiments, the UAI MAC CE is associated with a LCH or LCG and the WD 22 includes UAI MAC CE message in a PUSCH if LCP rules for the associated logical channel (LCH) or logical carrier group (LCG) is fulfilled; otherwise MAC procedures trigger a Scheduling Request for the scheduling request configuration associated with the LCH or LCG.

In some embodiments, MAC procedures in the WD 22 to trigger MAC CE signalling with traffic assistance information may be triggered by reception of a “Request for UAI” MAC CE. In such embodiments, the network node 16 may send “Request for UAI” MAC CE wherein the WD 22 responds with a UAI MAC CE comprising traffic assistance information provided by upper layer. In some embodiments, the “triggering” MAC CE received by the WD 22 is an “activation” MAC CE that activates periodic transmissions of UAI MAC CE by the WD 22.

In some embodiments, the WD 22 is configured on how to report UAI. The “activation” of the WD TADI reporting is triggered implicitly via, e.g., RRC reconfiguration procedure.

In some embodiments, the WD 22 is configured on how to report UAI via, e.g., RRC reconfiguration procedure but the initial state is deactivated. The “activation” of the WD TADI reporting may be triggered explicitly.

In some embodiments, the “deactivation” of the WD TADI reporting may be triggered by RRC or MAC CE (or another layer.)

In some embodiments, the WD 22 may be indicated/instructed, via RRC/MAC/other means, to report TADI either via RRC or MAC CE or other means explicitly.

In some embodiments, when the WD UAI reporting activation/deactivation is performed by MAC layer and the network node 16 centralized unit (CU) makes the decision or is involved in the decision making. For example, the network node 16 CU may indicate to network node 16-distributed unit (DU) via F1AP or F1 User Plan protocol.

In some embodiments, the conditions for triggering the MAC CE containing the assistance information is also included in the LogicalChannelConfig. The conditions for triggering MAC CE may for example be based on a timer that limits additional MAC CE for while after earlier MAC CE has already been triggered.

LogicalChannelConfig information element

```
    -- ASN1START
    -- TAG-LOGICALCHANNELCONFIG-START
```

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, |

kBps32, kBps64, kBps128, kBps256, kBps512,

kBps1024, kBps2048, kBps4096, kBps8192,

kBps16384, kBps32768, kBps65536, infinity},

| | |
|---|---|
| bucketSizeDuration | ENUMERATED {ms5, ms10, ms20, ms50, |

ms100, ms150, ms300, ms500, ms1000,

spare7, spare6, spare5, spare4, spare3,spare2,

spare1},

| | |
|---|---|
| allowedServingCells | SEQUENCE (SIZE (1..maxNrofServingCells- |

1)) OF ServCellIndex

OPTIONAL, --

PDCP-CADuplication

| | |
|---|---|
| allowedSCS-List | SEQUENCE (SIZE (1..maxSCSs)) OF |

| | |
|---|---|
| SubcarrierSpacing | OPTIONAL, -- Need R |

| | |
|---|---|
| maxPUSCH-Duration | ENUMERATED {ms0p02, ms0p04, |

ms0p0625, ms0p125, ms0p25, ms0p5, spare2, spare1}

OPTIONAL, --

Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId |

OPTIONAL, -- Need R

| | |
|---|---|
| logicalChannelSR-Mask | BOOLEAN, |
| logicalChannelSR-DelayTimerApplied | BOOLEAN, |

...,

| | |
|---|---|
| bitRateQueryProhibitTimer | ENUMERATED { s0, s0dot4, s0dot8, s1dot6, |

| | |
|---|---|
| s3, s6, s12,s30} | OPTIONAL -- Need R |

| | |
|---|---|
| } | OPTIONAL, -- |

Cond UL

| | | |
|---|---|---|
| TrafficAssistanceInformationUpdateTrigger ::= | BOOLEAN, | OPTIONAL, |

-- Need R

| | |
|---|---|
| TrafficAssistanceInformationUpdateTriggerConditions ... | OPTIONAL -- |

```
Need M
    -- Need R
      ...
    }
    -- TAG-LOGICALCHANNELCONFIG-STOP
    -- ASN1STOP
```

In some embodiments, the RRC configuration of MAC CE triggers is included in the MAC-CellGroupConfig IE seen below. The triggers would then be configured on a per cell group level.

```
  MAC-CellGroupConfig information element
  -- ASN1START
  -- TAG-MAC-CELLGROUPCONFIG-START
```

| | |
|---|---|
| MAC-CellGroupConfig ::= | SEQUENCE { |
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| | |
|---|---|
| skipUplinkTxDynamic | BOOLEAN, |

```
    ...,
    [[
```

| | |
|---|---|
| csi-Mask | BOOLEAN |

OPTIONAL, -- Need M

| | |
|---|---|
| dataInactivityTimer | SetupRelease { DataInactivityTimer } |

OPTIONAL -- Cond MCG-Only
]]

| | |
|---|---|
| macAssistanceInformationTrigger-Config | SetupRelease { |

MACAssistanceInformationTrigger-Config }
}

| | |
|---|---|
| DataInactivityTimer ::= | ENUMERATED {s1, s2, s3, s5, s7, s10, s15, s20, |

```
s40, s50, s60, s80, s100, s120, s150, s180}
  -- TAG-MAC-CELLGROUPCONFIG-STOP
  -- ASN1STOP
```

In some embodiments, the application informs the WD 22 about the intent to update the assistance information, which may be at some X amount time in the future. The WD 22 may then either signal this change directly, and then possibly include some information in the assistance information (TADI) about the delay until the updated application settings will take effect, or alternatively wait until the effect has taken place in the application. By reporting to the network before the actual change has taken place, the network may perform configurations of features in advance to appropriately align to when the updated settings taken effect.

In some embodiments, a first part of Traffic Assistance and Device Information (TADI), e.g., frame periodicity, etc., is transmitted by the WD 22 as a RRC message while a second part of TADI is transmitted by the WD 22 as MAC CE message. In some example embodiments, the RRC message is a WD Assistance Information message. In other example embodiments, the RRC message is a MeasurementReportAppLayer message, where the TCAIs is included as fields as highlighted part below (exemplified for ‘periodicity’):

MeasurementReportAppLayerList-rX ::= SEQUENCE (SIZE
(1..maxNrofAppLayerMeas-r17)) OF MeasReportAppLayer-rX

| | |
|---|---|
| MeasReportAppLayer-rX ::= | SEQUENCE { |
| measConfigAppLayerId-rX | MeasConfigAppLayerId-rX, |
| measReportAppLayerContainer-rX | OCTET STRING |

OPTIONAL,

| | |
|---|---|
| appLayerSessionStatus-rX | ENUMERATED {started, stopped} |

OPTIONAL,

| | |
|---|---|
| ran-VisibleMeasurements-rX | RAN-VisibleMeasurements-rX |

OPTIONAL
}

| | |
|---|---|
| RAN-VisibleMeasurements-rX ::= | SEQUENCE { |
| appLayerBufferLevelList-rX | SEQUENCE (SIZE (1..8)) OF |
| AppLayerBufferLevel-rX | OPTIONAL, |
| appLayerPeriodicityList-rX | SEQUENCE (SIZE (1..8)) OF |
| AppLayerPeriodicity-rX | OPTIONAL, |
| playoutDelayForMediaStartup-rX | INTEGER (0..30000) |

OPTIONAL,

| | |
|---|---|
| pdu-SessionIdList-rX | SEQUENCE (SIZE (1..maxNrofPDU-Sessions- |
| r17)) OF PDU-SessionID | OPTIONAL, |

```
    ...
  }
  AppLayerBufferLevel-r17 ::= INTEGER (0..30000)
  AppLayerPeriodicity-rX ::= ENUMERATED { p1, p2, ..., pN}
```

In some embodiments, the first or second part of TADI contains no TADIs, i.e., all TADI information is transmitted as MAC CE message or RRC message.

In some embodiments, the first and second part is configured by the network node 16. In some embodiments, the WD 22 indicates a capability or the WD 22 preference to split TADI into said first and second part. For example, the WD 22 may indicate that “XR frame jitter” is preferred/suitable to be transmitted as RRC message while “traffic statistics information” e.g., XR frame size distribution, XR frame rate is preferred/suitable to be transmitted as MAC CE message. The network node 16 may then configure the WD 22 such that first TADI part includes “XR frame jitter” while second TADI part includes “traffic statistics information”. In some embodiments, the MAC CE is generic such that entries comprise a TADI type and TADI value, e.g., the TADI MAC CE may include 3 bytes where first byte is the logical channel group identity and the second two bytes are “traffic statistics information” for two TADI types:

LCG ID

| | |
|---|---|
| TADI type 1 | TADI value 1 |
| TADI type 2 | TADI value 2 |

where the WD 22 may be configured with “TADI type 1” as XR frame size distribution and “TADI type 2” as XR frame rate. The “TADI value” may be the entry index in a table of values.

In some embodiments, where the RRC message is a MeasurementReportAppLayer message, the WD 22 is configured with one or more triggers to send a MeasurementReportAppLayer message. The one or more triggers may be one or more out of:
periodic triggers, i.e., the WD 22 transmits or deliver to lower layer the MeasurementReportAppLayer message when a timer expires and then re-starts the timer;
event-base triggers, i.e., a TADI change, a TADI exceeds a threshold where the threshold may absolute or relative:
   absolute trigger: current TCAI is above or below a threshold T;
   relative trigger: TADI_current>TADI_last_reported+T or TADI_current<TADI_last_reported−T.

In some embodiments, the WD 22 transmits a first set of TADIs in RRC UAI message while a second set of TADIs is transmitted as MeasurementReportAppLayer message. In some embodiments, the first set of TCAIs includes a subset of second set of TADIs. For example, first and second set of TADIs may be:
First set of TADIs: {‘set of possible periodicities’, ‘set of frame size distribution’, ‘current periodicity’, ‘current frame size distribution’},
Second set of TADIs: {‘current periodicity’, ‘current frame size distribution’}

In some examples, some TADIs are related wherein first set of TADIs may comprise a set of possible TADI sets. For example, if the periodicity is p1 then the frame size distribution is d1 and the first set of TADIs may be:
First set of TADIs: {‘set of possible [periodicity, frame size distribution] pairs’, ‘current periodicity’, ‘current frame size distribution’}.

Some embodiments may include one or more of the following:
Embodiment A1. A network node configured to communicate with a wireless device (WD), the network node configured to, and/or comprising a radio interface and/or comprising processing circuitry configured to:
receive an indication of a traffic assistance information capability of the WD; and
configure the WD with a timer configuration to configure a periodicity of traffic assistance information messages.
Embodiment A2. The network node of Embodiment A1, wherein the timer configuration configures the periodicity based at least in part on a priority of a traffic assistance information message.
Embodiment A3. The network node of Embodiment A1, wherein the timer configuration includes a trigger to trigger reporting of traffic assistance information messages.
Embodiment A4. The network node of any of Embodiments A1-A3, the network node, radio interface and/or processing circuitry are further configured to configure a format of traffic assistance information.
Embodiment A5. The network node of any of Embodiments A1-A4, wherein the network node, radio interface and/or processing circuitry are further configured to receive traffic assistance information messages on at least one of radio resource control, RRC, signaling and medium access control, MAC, control element, CE, signaling.
Embodiment B1. A method implemented in a network node, the method comprising:
receiving an indication of a traffic assistance information capability of the WD; and
configuring the WD with a timer configuration to configure a periodicity of traffic assistance information messages.
Embodiment B2. The method of Embodiment B1, wherein the timer configuration configures the periodicity based at least in part on a priority of a traffic assistance information message.
Embodiment B3. The method of Embodiment B1, wherein the timer configuration includes a trigger to trigger reporting of traffic assistance information messages.
Embodiment B4. The method of any of Embodiments B1-B3, further comprising configuring a format of traffic assistance information.
Embodiment B5. The method of any of Embodiments B1-B4, further comprising receiving traffic assistance information messages on at least one of radio resource control, RRC, signaling and medium access control, MAC, control element, CE, signaling.
Embodiment C1. A wireless device (WD) configured to communicate with a network node, the WD configured to, and/or comprising a radio interface and/or processing circuitry configured to
transmit an indication of a traffic assistance information capability of the WD;
receive a timer configuration to configure a periodicity of traffic assistance information messages; and
configure the periodicity of traffic assistance information messages according to the timer configuration.
Embodiment C2. The WD of Embodiment C1, wherein the timer configuration configures the periodicity of traffic assistance information messages based at least in part on a priority of a traffic assistance information message.
Embodiment C3. The WD of Embodiment C1, wherein the WD, radio interface and/or processing circuitry are further configured to report traffic assistance information messages in response to a trigger from the network node.
Embodiment C4. The WD of any of Embodiments C1-C3, wherein the timer configuration includes a format for the traffic assistance information messages.
Embodiment C5. The WD of any of Embodiments C1-C4, wherein the WD, radio interface and/or processing circuitry are further configured to transmit the traffic assistance information messages on at least one of radio resource control, RRC, signaling and medium access control, MAC, control element, CE, signaling.
Embodiment D1. A method implemented in a wireless device (WD), the method comprising
transmitting an indication of a traffic assistance information capability of the WD;
receiving a timer configuration to configure a periodicity of traffic assistance information messages; and
configuring the periodicity of traffic assistance information messages according to the timer configuration.
Embodiment D2. The method of Embodiment D1, wherein the timer configuration configures the periodicity of traffic assistance information messages based at least in part on a priority of a traffic assistance information message.
Embodiment D3. The method of Embodiment D1, further comprising reporting traffic assistance information messages in response to a trigger from the network node.
Embodiment D4. The method of any of Embodiments D1-D3, wherein the timer configuration includes a format for the traffic assistance information messages.
Embodiment D5. The method of any of Embodiments D1-D4, further comprising transmitting the traffic assistance information messages on at least one of radio resource control, RRC, signaling and medium access control, MAC, control element, CE, signaling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 5GC | 5G Core Network |
| AMF | Access and Mobility Management Function |
| DRB | Data Radio Bearer |
| LCH | Logical Channel |
| LCG | Logical Channel Group |
| MAC CE | MAC Control Element |
| TADI | Traffic Assistance and Device Information |
| XR | extended Reality |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD configured to:
determine traffic assistance and device information, TADI, the TADI including updated traffic pattern information, the updated traffic pattern information including jitter information associated with traffic flows; and
transmit the TADI to the network node.

2.-5. (canceled)

6. The WD of claim 1, wherein the WD is configured to apply a prohibition timer to prohibit additional transmissions of the TADI for a duration of the prohibition timer, wherein a start time of the prohibition timer is configured by the network node via a radio resource control, RRC, message, and wherein the prohibition timer is applied to a first set of TADI transmissions having a lower priority that a second set of TADI transmissions.

7.-11. (canceled)

12. The WD of claim 1, wherein the WD is configured to transmit the TADI in a medium access control, MAC, control element, CE, the MAC CE being transmitted in a physical uplink shared channel, PUSCH, when the WD has an uplink grant, wherein the MAC CE is associated with one of a logical channel and a logical channel group, and the WD is configured to include the MAC CE in a physical uplink shared channel, PUSCH, when logical channel prioritization rules for the one of the logical channel and the logical channel group are fulfilled.

13.-15. (canceled)

16. A method in a wireless device, WD, configured to communicate with a network node, the method comprising:
determining traffic assistance and device information, TADI, the TADI including updated traffic pattern information, the updated traffic pattern information including jitter information associated with traffic flows; and
transmitting the TADI to the network node.

17. The method of claim 16, wherein the jitter information is at least one of a standard deviation, range, maximum and minimum associated with the traffic flows.

18. The method of claim 16, wherein the traffic flows are mapped to one of a data radio bearer, a logical channel and a logical channel group.

19. The method of claim 16, further comprising signaling a capability to provide the TADI.

20. The method of claim 16, further comprising transmitting the TADI in a radio resource control, RRC, message.

21. The method of claim 16, further comprising applying a prohibition timer to prohibit additional transmissions of the TADI for a duration of the prohibition timer.

22. The method of claim 21, wherein a start time of the prohibition timer is configured by the network node via a radio resource control, RRC, message.

23. The method of claim 21, wherein the prohibition timer is applied to a first set of TADI transmissions having a lower priority that a second set of TADI transmissions.

24. The method of claim 16, further comprising applying a minimum time between TADI transmissions.

25. The method of claim 16, wherein the TADI is transmitted in response to a request from the network node.

26. The method of claim 16, further comprising deactivating TADI transmissions when deactivation is indicated by the network node.

27. The method of claim 16, further comprising transmitting the TADI in a medium access control, MAC, control element, CE.

28. The method of claim 27, wherein the MAC CE is transmitted in a physical uplink shared channel, PUSCH, when the WD has an uplink grant.

29. The method of claim 27, wherein the MAC CE is associated with one of a logical channel and a logical channel group, and the method includes configuring the WD to include the MAC CE in a physical uplink shared channel, PUSCH, when logical channel prioritization rules for the one of the logical channel and the logical channel group are fulfilled.

30. The method of claim 16, wherein a first part of the TADI is transmitted in a radio resource control, RRC, message and a second part of the TADI is transmitted in a medium access control, MAC, control element, CE, message.

31. A network node configured to communicate with a wireless device, WD, the network node configured to:
receive traffic assistance and device information, TADI, the TADI including updated traffic pattern information, the updated traffic pattern information including jitter information associated with traffic flows; and
schedule transmissions based at least in part on the TADI.

32. (canceled)

41. A method in a network node configured to communicate with a wireless device, WD, the method comprising:
receiving traffic assistance and device information, TADI, the TADI including updated traffic pattern information, the updated traffic pattern information including jitter information associated with traffic flows; and
scheduling transmissions based at least in part on the TADI.

42.-50. (canceled)
